(19) United States
(12) Patent Application Publication
(10) Pub. No.: US 2003/0122929 A1
(43) Pub. Date: Jul. 3, 2003

(54) Vehicular camera system

(76) Inventors: B. Philip Minaudo, Sterling Heights, MI (US); Theodore Adamczyk JR., Macomb, MI (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/037,829

(22) Filed: Jan. 3, 2002

(51) Int. Cl. H04N 7/18

(52) U.S. Cl. 348/148; 348/143

(57) ABSTRACT

A vision enhancement system for use on a vehicle includes a camera mounted behind the exterior body of the vehicle. A moveable door is mounted in the vehicle's body and is positioned in the camera's line of sight. The door is capable of being moved between a closed position and an open position. An actuator is coupled to the door for selectively positioning the door in either an open or closed position.

### TECHNICAL FIELD

This invention relates generally to camera systems, and more particularly to a vision enhancing camera system for use on a motor vehicle.

### BACKGROUND OF THE INVENTION

From their inception, motor vehicles have been provided with vision enhancing equipment to assist the driver in his/her operation of the vehicle. For example, passenger, recreational, and commercial vehicles are generally provided with a system of internal and external mirrors disposed at the left (driver) side and right (passenger) side of the vehicle, and in most cases with a rear-view (center) mirror that permits viewing through the rear windshield. These mirrors, unfortunately, provide a less than satisfactory view of events occurring to the rear of the vehicle and to the right and left sides of the vehicle which is extremely important for detecting another vehicle in another adjacent lane should the operator be planning to make a turn or lane change. Mirrors permit viewing of only a limited area around the outside of the vehicle and often leave blind spots resulting in the operator's failure to see other vehicles. This increases the likelihood that the driver might steer his/her vehicle into an unseen adjacent vehicle.

There are several other significant disadvantages associated with traditional vehicular mirror systems. For example, the mirrors sometimes require adjustment causing the driver to divert his attention from the road ahead. Obviously, safe operation of the vehicle dictates that such diversions be minimized. Also, objects and passengers can block the driver's mirror-assisted view of the areas outside the vehicle. Those mirrors that are positioned outside the vehicle (right and left sides) produce a significant amount of wind drag since they extend from the sides of the vehicle thus reducing engine efficiency. Furthermore, the side view mirrors are subject to being damaged if, for example, the vehicle is parked or driven into areas having restricted sideways clearance. Finally, conventional vehicular mirror systems provide little or no night vision assistance. If fact, if another vehicle is approaching from the rear at night with it's headlights on, the glare from that vehicle's headlights is reflected directly into the eyes of the leading vehicle's driver which could produce momentary blindness.

To alleviate some of the above-described problems associated with vehicular mirror systems, a number of video camera systems have been suggested for enhancing the driver's view. For example, it is known to mount rear-view video cameras in box-light housings carried on arms attached to the exterior to motor vehicles. These cameras are generally exposed and visible and are therefore targets for vandals and thieves. They are also exposed to damage from the elements (e.g., dirt, rain, snow, etc.) and collisions with objects outside the vehicle. Additionally, such exterior camera's detract from the esthetic appeal of the exterior of the vehicle since they often give the impression of being added as an afterthought and do not give the impression of being an integrated component of the vehicle.

To improve the performance and appearance of the vehicular camera systems, it is known to deploy the cameras in a protective environment; e.g., within the housing of a running light, tail light, reflector, etc. It is also known to deploy the camera in a housing or shroud that is in the form of an aerodynamic fairing which protects the camera and minimizes it's protuberance from the side of the vehicle. In one case, a mounting arrangement is provided that automatically extends the camera outside the vehicle's body when the vehicle is started and retracts or hides the camera inside the vehicle's body when the vehicle is turned off.

Other vehicular vision enhancement camera systems are known which record events occurring in the exterior and/or in front of a vehicle. For example, it is known to mount a camera within the passenger compartment (e.g., in a sun visor or dashboard) for displaying and recording events occurring in front and inside of a vehicle. The speedometer inside a law enforcement vehicle may be recorded while at the same time recording a car being followed.

It is ironic that while the majority of driving takes place during the day, most traffic fatalities occur at night. Some of the causes of this are driver fatigue, glare from approaching vehicles, increased speed due to reduced traffic congestion, and poor visibility. In an attempt to render nighttime driving easier and safer, night vision enhancement vehicular camera systems have been developed. For example, an infrared camera can be utilized to provide an image of the roadway in front of a vehicle, revealing sources of infrared radiation (e.g., humans, animals, etc.) that are beyond the range of the vehicle's headlights. Such systems generally utilize a monitor to display a thermal image of the roadway in front of the vehicle. Unfortunately, the cameras of such systems are generally mounted in the front or on top of the vehicle and therefore suffer from some of the disadvantages pointed out above; i.e. vandalization, exposure to the elements, lack of esthetic appeal, etc.

In view of the foregoing, it should be appreciated that it would be desirable to provide a vehicular vision enhancement system and camera mounting arrangement that is secure, reliable, and esthetically pleasing.

### SUMMARY OF THE INVENTION

In accordance with the teachings of the present invention, there is provided a vision enhancing system for use on a vehicle which includes a camera mounted to the vehicle behind a portion of the vehicle's exterior body. A door is moveably mounted in the body portion and aligned with the camera's line of sight. The door is capable of being moved between a closed position and an open position. An actuator selectively positions the door in one of the open and closed positions.

### BRIEF DESCRIPTION OF THE DRAWINGS

The present invention will hereafter be described in conjunction with the accompanying drawings wherein like numerals denote like elements, and:

FIG. 1 is a graphical representation of a vehicular vision enhancing system in accordance with the teachings of the present invention; and

FIG. 2 is a graphical representation of a vehicle utilizing the inventive enhancement system.

### DESCRIPTION OF THE PREFERRED EMBODIMENT

The following detailed description of a preferred embodiment of the invention is exemplary in nature and is not intended to limit the invention or the application or use thereof.

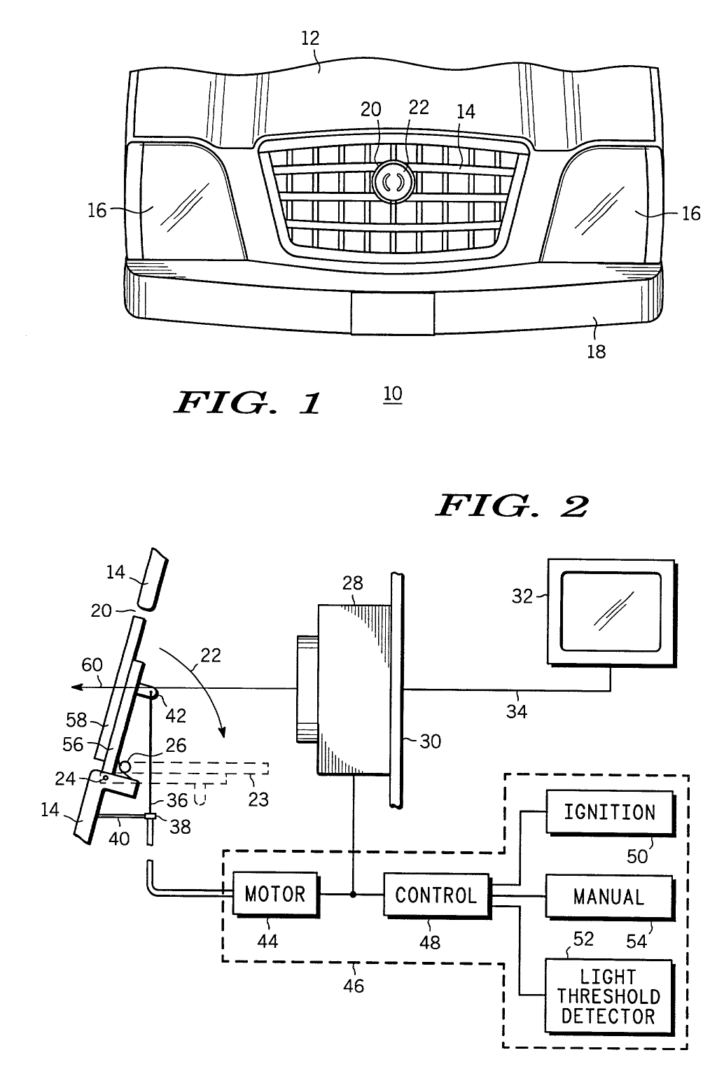

Referring to FIG. 1, there is shown the front of a vehicle 10 including a hood 12, a grill 14, headlights 16, and front bumper 18. As can be seen, grill 14 has an opening 20 through which a cover or door 22 is visible. Door 22 is shown as having a decorative pattern 24 thereon (e.g., the manufacturer's logo); however, such decoration is not required. Furthermore, while opening 20 and door 22 are shown as generally circular, any desired shape can be utilized.

FIG. 2 illustrates grill 14, door 22, and opening 20 in cross-sectional form. Door 22 is pivotally coupled to grill 14 as is shown at pin 24 and is biased closed (i.e., in position shown in FIG. 1) by a spring 26; however, it should be clear that any suitable biasing means may be utilized. Positioned behind opening 20 and under hood 12 (shown in FIG. 1) is a camera 28 that is secured in place by mounting bracket 30. The images received by camera 28 may be displayed and viewed by the operator of the vehicle on display monitor 32 via link 34. Camera 28 may be a conventional video camera or a night vision camera. It should be understood, however, that any number of detection devices may be substituted for camera 28; i.e., a radar detector, an adaptive cruise control device, etc.

A cable 36 guided by grommet 38 positioned within grommet retainer 40 has a first end coupled to door 22 as is shown at 42. The other end of cable 38 is mounted to motor 44 located within actuator 46. A control unit 48 has an output coupled to motor 44 and to camera 28 in order to activate them when circumstances dictate. For example, control unit 48 could automatically activate motor 44 and camera 28 when the ignition is turned on as is represented by ignition block 50. The system could be automatically activated when exterior ambient light falls below a certain threshold as is indicated by light threshold detector 52. Alternatively or additionally, the system may be activated by means of a manual switch 54, which is under the control of the driver of the vehicle. The inventive vision enhancement system is powered by the vehicle's source of electrical energy (e.g., the vehicle's battery).

Door 22 may consist of a single plate, decorative if desired (or, as is shown in FIG. 2, a first plate 56 and a second plate 58). Plate 56 is pivotally coupled to grill 14 at pin 24 and has a shape that preferentially contours to the shape of opening 20. Plate 58 is attached to plate 56 and, if viewed from the front of the vehicle, is decorative and/or ornamental. It may, for example, comprise an emblem or representation of the vehicle's manufacturer's crest or logo.

The inventive vision enhancement system operates as follows. Upon the occurrence of one or more events, control unit 48 activates motor 44 and camera 28. As described earlier, the events that result in activating the system could include turning the ignition on (50), darkness (52), activation of a manual switch (54), or any combination of these. Activation of motor 44 causes cable 36 to lower door 22 against the biasing force of spring 26 until door 22 is positioned as is shown at 23. Camera 28 now has an unobstructed line of sight through opening 20 of the roadway in front of the vehicle as is indicated by arrow 60, and the images received by camera 28 are displayed on monitor 32. If camera 28 is a night vision infrared camera, the driver's view of the roadway ahead is enhanced beyond that which would be visible in the beams of the vehicle's headlights. When the system is turned off, as for example by turning off the ignition or otherwise manually switching the system off, motor 44 is deactivated as is camera 28, and door 22 is closed under the force of spring 26. When door 22 is closed, it not only provides a measure of protection for camera 28 from the elements, but also at the same time gives the appearance of being a contiguous, integral and perhaps decorative part of the vehicle's exterior grill.

While the preferred exemplary embodiment has been presented in the foregoing detailed description, it should be appreciated that a vast number of variations in the embodiments exist. It should also be appreciated that this preferred embodiment is only an example, and is not intended to limit the scope, applicability, or configuration of the invention in any way. Rather, the foregoing detailed description provides those skilled in the art with a convenient roadmap for implementing a preferred exemplary embodiment of the invention. It should be understood that various changes may be made in the function and arrangement of elements described in the exemplary preferred embodiment without departing from the spirit and scope of the invention as set forth in the appended claims.

1. A vision enhancement system for use on a vehicle, the vehicle having an exterior body portion, comprising:
a camera mounted to the vehicle behind the exterior body portion;
a door moveably mounted in the body portion, said door positioned in said camera's line of sight and capable of being moved between a closed position and an open position; and
an actuator for selectively positioning said door in one of said open and closed positions.

2. A vision enhancement system according to claim 1 wherein said body portion includes a grill.

3. A vision enhancement system according to claim 2 wherein said door has a decorative exterior.

4. A vision enhancement system according to claim 3 wherein said camera is a night vision camera.

5. A vision enhancement system according to claim 3 wherein said door is pivotally coupled to said grill.

6. A vision enhancement system according to claim 5 further comprising a spring coupled to said door and to said grill for biasing said door in a normally closed position.

7. A vision enhancement system according to claim 6 wherein said actuator comprises:
a motor; and
a cable coupled to said motor and to said door for opening said door when said motor is energized.

8. A vision enhancement system according to claim 7 further comprising a switch for energizing said motor.

9. A vision enhancement system according to claim 7 further comprising a light detector for energizing said motor when exterior ambient light falls below a predetermined threshold.

10. A vision enhancement system according to claim 7 further comprising a control unit for energizing said motor when said vehicle is turned on.

11. A vision enhancement system according to claim 1 wherein said camera is turned on when said actuator is energized.

12. A vision enhancement system according to claim 7 further comprising a display for displaying an image taken by said camera.

13. A vision enhancement system according to claim 4 further comprising a display for displaying a thermal image taken by said night vision camera.

14. A vision enhancement system according to claim 2 further comprising a decorative emblem coupled to an exterior of said door.

15. A night vision enhancement system for use on a vehicle, the vehicle having a front grill, said system comprising:
a night vision camera mounted behind the grill and having a forwardly directed line of sight;
a door having a decorative exterior pivotally coupled to said grill in said camera's line of sight and capable of being moved between an open position and a closed position;
a motor coupled to said door for selectively positioning said door in one of said open and closed positions; and
a controller for energizing said motor.

16. A night vision enhancement system according to claim 15 further comprising a spring coupled to said door and to said grill for biasing said door in a normally closed position.

17. A night vision enhancement system according to claim 16 further comprising a cable coupled between said door and said motor.

18. A night vision enhancement system according to claim 17 wherein said controller comprises a manual switch.

19. A night vision enhancement system according to claim 17 wherein said controller comprises a light detector for energizing said motor when exterior ambient light falls below a predetermined threshold.

20. A night vision enhancement system according to claim 17 wherein said motor controller is coupled to an ignition system of the vehicle for opening said door when the ignition system is turned on.

21. A night vision enhancement system according to claim 16 further comprising a display for displaying an image received by said camera.
